(19) United States
(12) Patent Application Publication
(10) Pub. No.: US 2021/0355630 A1
(43) Pub. Date: Nov. 18, 2021

(54) BIO-BASED ARTIFICIAL LEATHER

(71) Applicant: STUDER CABLES AG, Daniken (CH)

(72) Inventors: MICHEL PROBST, Rheinfelden (CH); MELANIE EGGERT, Aarau (CH); CONRAD GUENTHARD, Rupperswil (CH)

(21) Appl. No.: 17/283,664

(22) PCT Filed: Oct. 24, 2019
(86) PCT No.: PCT/EP2019/078967

§ 371 Date: Apr. 8, 2021

(30) Foreign Application Priority Data
Oct. 25, 2018 (DE) 10 2018 126 646.4

(51) Int. Cl. D06N 3/00; D06N 3/04

(52) U.S. Cl. CPC D06N 3/005; D06N 3/0002; D06N 2213/03; D06N 2211/28; D06N 3/045

(57) ABSTRACT

The present invention relates to a layered material and a method of producing the same.

The layered material has one or more layers, including at least one foamed layer, said foamed layer comprising a first polymer and a second polymer, said foamed layer having a high BBC.

The present invention relates to a bio-based artificial leather in the form of a layered material and a method for its production.

### STATE OF THE ART

Artificial leather has been known for many years and offers the advantage that the production of products made of artificial leather does not require animal products or animal leather. This is advantageous because the use of animal products has an environmental impact.

A large number of artificial leathers are based on the use of polyvinyl chloride (PVC), polyurethane (PU), or mixtures thereof. However, PVC-based products have the disadvantage that toxic hydrogen chloride (HCl) is generated during combustion. The use of starting materials containing chlorine also has a negative impact on the eco-balance of such products. The eco-balance of known artificial leathers is also generally not very good, since petroleum-based raw materials are used as starting materials and therefore sustainable production is not possible.

US 2013/0022771 A1 describes a bio-based copolymer based on an ethylene oxide and/or propylene oxide monomer containing ¹⁴C carbon isotope. These polyethers can be combined with further polymers, for example polyamides. Although the preparation of ethylene and propylene as starting materials for the ethylene oxide and/or propylene oxide monomers is also described, the use of polyethylene or polypropylene is not proposed, US 2013/0022771 A1 considers the copolymers described therein to be suitable for the production of artificial leather. However, the document does not contain any working examples that could show the properties of the materials. Whether the copolymers can actually provide suitable material properties is therefore not apparent to the skilled person.

US 2011/0183099 A1 describes bio-based thermoplastic elastomers that are said to be suitable for, among other things, artificial leather. The thermoplastic elastomers are based on a combination of a tetrahydrofuran monomer and a rigid block of polyamides, polyurethanes or polyesters. As in US 2013/0022771 A1, US 2011/0183099 A1 does not contain any working examples showing the material properties. EP2342262 (B1) discloses polyamide and polytetramethylene glycol block copolymers.

In view of the above problems, there was a need to provide an improved artificial leather.

### SUMMARY OF THE INVENTION

In the context of the present invention, it was found that it is possible to improve the eco-balance of artificial leathers by using renewable raw materials as starting materials for the plastics used.

Although the supply of plastics made from renewable raw materials is very limited, it has been possible to develop suitable compositions for artificial leather that meet the (physical and chemical) material requirements. In particular, artificial leathers require a special feel (haptic) to achieve a leather appearance, as well as high flexibility coupled with good tear resistance.

The very good material properties of the artificial leathers according to the invention could be improved even further towards the properties of natural leathers by electron beam crosslinking. This can be seen, for example, in the low hot set value (<50%, determined by the thermal expansion test for crosslinked materials (DIN EN 60811-508, VDE 0473-811-507)) at 200° C., which indicates the elongation of the material. At the same time, surprisingly, a very good value can be maintained in terms of flexibility, which can be seen from a very low σ₁₀ value, where the σ₁₀-value indicates the strength at 10% elongation.

Good “hot set” properties of the materials described herein, generally do not change the feel and flexibility properties much. But the good “hot set” properties improve the tear strength properties over a wider temperature range.

The use of renewable raw materials leads to an improved eco-balance and, in particular, to a conservation of petroleum resources or to an avoidance of the environmental damage associated with their consumption. In addition, consumer acceptance can be increased, as renewable raw materials enjoy a better reputation compared to petroleum. In particular, the sugarcane used in the production of artificial leather absorbs CO₂ during the cultivation phase (60 tons CO₂/year/hectare). Water consumption is also significantly lower compared to genuine leather and no toxic chemicals (for example, chromated compounds and dyes) are used as in genuine leather processing.

In addition, petroleum is important as a resource for many applications where it is not readily possible to switch to substitutes, and should be preserved as best as possible for future generations.

One challenge in the production of artificial leather is to achieve a visual and sensory leather impression while at the same time achieving material properties that are also comparable to the natural product. In the context of the present invention, for example, it was found that the use of bio-based plastics, such as LLDPE, can easily cause the material to become too stiff. Since very few bio-based plasticizers are available to date, the use of plasticizers leads to a lowering of the BBC (Bio-Based Content) value. In embodiments according to the invention, therefore, either no plasticizer or only one bio-based plasticizer is preferably present.

In contrast to partially bio-based polyurethane, where only the polyols from starting materials are bio-based, bio-based polyethylene can be produced with a very high BBC value of e.g. 87%, As mentioned above, the use of PVC is not an alternative to polyurethane due to its eco-balance. In particular, the layered materials according to the invention can have improved mechanical properties compared to PU artificial leather (see examples).

Bio-based polyethylene, especially bio-based LLDPE, is readily commercially available and can be produced with a high BBC value. However, it has been shown in the present invention that LLDPE cannot provide the desired flexibility in artificial leather. Surprisingly, however, it has been possible to develop polyethylene-containing polymer blends that both provide the required material properties and exhibit a high BBC value. Here, polyethylene is combined with a more flexible second polymer. In particular, the combination of biobased LLDPE and biobased EPDM has proven to be particularly advantageous, EPDM (ethylene propylene diene monomer) is particularly advantageous because it can also be crosslinked very well by electron beam.

Surprisingly, the compositions according to the invention, in particular the combination of polyethylene, preferably LLDPE, and EPDM, are very well crosslinkable by electron beam, and it should be possible to produce artificial leathers with high leather-like properties, both in terms of optical, feel and sensory properties, as well as high performance.

### DETAILED DESCRIPTION OF THE INVENTION

The present invention relates to the following embodiments:

1. Layered material with four or more layers with the following order:
Textile support layer;
foamed layer A;
non-foamed top layer; and
varnish layer; where

Layer a has:
0-50 or 10-50, preferably 0-20, weight percent polyethylene as the first polymer,
10-80 or 10-50, preferably 30-80, weight percent ethylene propylene diene monomer (EPDM) as the second polymer;
10-40 weight percent filler, in particular calcium carbonate, such as chalk, wherein the organic component of layer A has a bio-based carbon content (BBC) of at least 50% as determined by ASTM D6866-16 Method B (AMS); and

wherein the layered material has a thickness of up to 4 cm. Preferably, the top layer also has a bio-based carbon content (BBC) of at least 50%, determined according to ASTM D6866-16 Method B (AMS). The preferred values for the bio-based carbon content (BBC) described herein apply to both layer A and the non-foamed top layer.

The polyethylene as “first polymer” may be present in the (preferably foamed) layer A in an amount of 0-20, 20-40, 23-28, or 20-35, but preferably in an amount of 0-12, or 5-12 weight percent and/or the EPDM may be present in an amount of 25-50, or 35-50 weight percent, but preferably 35-80 or 35-65 weight percent.

For example, the varnish layer may contain, or consist of, acrylic resin, polyurethane, and/or polytetrafluoroethylene (Teflon).

1a. Layered material having one or more layers, including at least one layer A, which is preferably a foamed layer, said layer A having:
0-50, preferably 0-12, or 5-12, weight percent polyethylene, preferably LLDPE, as the first polymer,
30-80, preferably 50-80, weight percent ethylene propylene diene monomer (EPDM) as the second polymer;
10-40 weight percent filler, in particular calcium carbonate, such as chalk, wherein the organic component of the (foamed) layer A has a bio-based carbon (BBC) content of at least 50% as determined by ASTM D6866-16 Method B (AMS);

and wherein

the layered material has a thickness of up to 4 cm.

1b. Layered material having one or more layers, including at least one layer A, which is preferably a foamed layer, said layer A having:
6-9, preferably about 7.5, weight percent polyethylene, preferably LLDPE, as the first polymer,
55-65, preferably about 60, weight percent ethylene propylene diene monomer (EPDM) as the second polymer;
10-40 weight percent filler, in particular calcium carbonate, such as chalk, wherein the organic component of the (foamed) layer A has a bio-based carbon (BBC) content of at least 50% as determined by ASTM D6866-16 Method B (AMS);

and wherein

the layered material has a thickness of up to 4 cm.

2. The layered material according to embodiment 1, 1a or 1b, wherein the foamed layer A has been extruded or calendered using a blowing agent.

3. The layered material according to embodiment 1, 1a, 1b or 2, wherein the polyethylene in the (preferably foamed) layer A is selected from the group consisting of VLDPE, LDPE, HDPE, and LLDPE, preferably LLDPE.

4. The layered material according to any of the preceding embodiments, wherein the thickness of the layered material is up to 2 cm, for example 0.01 cm to 1.0 cm or 0.01 to 0.5 cm.

5. The layered material according to any of the preceding embodiments, wherein the total amount of the first and the second polymer in the (preferably foamed) layer is at least 50 weight percent, or 55-60 weight percent, for example 55-70, preferably 60-80 weight percent.

6. The layered material according to any of the preceding embodiments, wherein at least one further polymer is present in the (preferably foamed) layer A.

7. The layered material according to any of the preceding embodiments, wherein the foamed layer has been extruded or calendered using a blowing agent, e.g. azodicarboxamide or hollow microspheres, for example in an amount of 0.2-10, or 0.2-3%, by weight.

8. The layered material according to any of the preceding embodiments, wherein the (preferably foamed) layer A is radiation crosslinked with electron beams. As mentioned above, the layered material according to the invention can be radiation crosslinked to achieve improved properties. However, this is not absolutely necessary. Radiation crosslinking enables improvement of certain properties (for example, mechanical properties, thermal resistance, and durability).

8′. The layered material according to any of the preceding embodiments, wherein the foamed layer has been chemically crosslinked (e.g., with silanes or peroxide).

9. The layered material according to any of the preceding embodiments, wherein the (preferably foamed) layer A has a density of between 0.3 and 1.2 g/cm³, for example 0.5 and 0.8 g/cm³.

10. The layered material according to any of the preceding embodiments, wherein the (preferably foamed) layer A, for example being 0.1 cm thick, is electron beam crosslinked at a voltage of 1.05 MeV, with an energy of at least 50 kGy, 100 kGy, 150 kGy, 200 kGy, or 250 kGy.

11. The layered material according to any of the preceding embodiments, wherein the (preferably foamed) layer A has a hot set at 200° C. of less than 100%, preferably less than 50% or less than 30%, for example 10-30%, measured according to DIN EN 60811-507 (VDE 0473-811-507)—Thermal expansion test for crosslinked materials.

12. The layered material according to any of the preceding embodiments, wherein the (all) polymers in the (preferably foamed) layer A have a bio-based carbon content of at least 50%, at least 70%, preferably at least 80%, determined according to ASTM D6866-16 Method B (AMS).

13. The layered material according to any of the preceding embodiments, wherein the (preferably foamed) layer A has a σ₁₀ value of less than 10 MPa (megapascal), preferably less than 7 MPa, for example 1-7 MPa, or 1-3 MPa, measured on a 1 mm plate, measured according to DIN EN 60811-501 (VDE 0473-811-501).

14. The layered material according to any of the preceding embodiments, wherein the blowing agent used in the foamed layer is an expandable lightweight filler or a gas-evolving chemical blowing agent, for example azodicarboxamide.

15. The layered material according to any of the preceding embodiments, wherein the foamed layer comprises expanded hollow microspheres, preferably polymer-based hollow microspheres (for example EXPANCEL from the company AKZO NOBEL or ADVANCEL from the company SEKISUI) or mineral hollow microspheres (e.g. alumino-silicates).

16. The layered material according to any of the preceding embodiments, wherein the non-foamed top layer comprises:
1-20 weight percent polyethylene as the first polymer,
30-80 weight percent ethylene propylene diene monomer (EPDM) as the second polymer;
10-40 weight percent filler,

wherein the organic component of the top layer has a bio-based carbon (BBC) content of at least 50%, as determined by ASTM D6866-16 Method B (AMS); and

wherein the layered material has a thickness of up to 4 cm; preferably, the material of layer A and the top layer is identical, with the difference that the top layer is not foamed and, in particular, has no blowing agents.

The varnish layer is preferably 5-100 μm, more preferably 5 to 20 μm thick and preferably contains or consists of acrylic resin, polyurethane and/or polytetrafluoroethylene (Teflon). The varnish layer gives the artificial leather UV resistance and a pleasant feel.

17. The layered material according to any of the preceding embodiments, in the form of a film or tape.

18. The layered material according to any of the preceding embodiments, wherein the second polymer in the (preferably foamed) layer is ethylene propylene diene monomer (EPDM), or ethylene-vinyl acetate copolymer (EVA).

19. The layered material according to any of the preceding embodiments, wherein the polyethylene in the (preferably foamed) layer A is an LLDPE and the second polymer is ethylene-vinyl acetate copolymer (EVA).

20. The layered material according to any of the preceding embodiments, wherein the polyethylene in the (preferably foamed) layer A is an LLDPE and the second polymer is ethylene-propylene-diene monomer (EPDM).

21. The layered material according to any of the preceding embodiments, wherein the polyethylene is present in the (preferably foamed) layer A in an amount of 0-15, preferably 1-15 weight percent and the second polymer is ethylene propylene diene monomer (EPDM) and is present in an amount of 40-80, or 40-70, preferably 40-65 weight percent.

22. The layered material according to any of the preceding embodiments, wherein the foamed layer comprises, preferably consists of:
1-15 weight percent of polyethylene,
50-80 weight percent ethylene propylene diene monomer (EPDM), as the second polymer,
10-40 weight percent filler(s), for example chalk,
1-3 weight percent expanded hollow microspheres or standard blowing agent,
0-3 weight percent silicone additive
0.5-3 weight percent antioxidant and UV absorber.

23. The layered material according to any of the preceding embodiments, wherein the foamed layer comprises, preferably consists of:
1-15 weight percent of polyethylene,
50-80 weight percent ethylene propylene diene monomer (EPDM), as the second polymer,
10-40 weight percent filler(s), for example chalk,
1-3 weight percent expanded hollow microspheres,
1-3 weight percent ethylene vinyl acetate copolymer (EVA),
1-2 weight percent silicone additive, and
0-0.5 weight percent of antioxidant.

24. The layered material according to any of the preceding embodiments, wherein the (preferably foamed) layer A contains pigments and/or dyes.

25. The layered material according to any of the preceding embodiments, wherein the (preferably foamed) layer A is applied directly to a support layer.

26. The layered material according to any of the preceding embodiments, wherein the support layer is a fabric layer.

27. The layered material according to any of the preceding embodiments, wherein the fabric layer is composed of cotton, flax fiber and polyester, e.g., 50 weight percent cotton and 50 weight percent polyester.

28. The layered material according to any of the preceding embodiments, wherein the (preferably foamed) layer A contains neither polyvinyl chloride nor polyurethane.

29. The layer material according to any of the preceding embodiments, wherein the (preferably foamed) layer A contains no plasticizers, or only bio-based plasticizers.

30. The layered material according to any of the preceding embodiments, wherein the layered material is vegan or does not contain animal starting materials.

31. Method of preparing a layered material according to any of the preceding embodiments, comprising:
a) providing the textile support layer, the composition for layer A, and the composition for the non-foamed top layer,
b) extruding or calendering the components of step (a) into a layered material, and
c) applying the varnish layer to the layer material from step b).

The first three layers are closely bonded together because the working temperature during coextrusion or during calendering is higher than the softening temperature of the foamed layer and the top layer.

The coating is then applied as a liquid dispersion to the top layer a separate step and dried.

Before applying the varnish layer, it may be necessary to perform a pretreatment, for example a surface activation by a cold plasma corona treatment, to activate the surface of the top layer and enable good adhesion of the varnish.

32. The method of embodiment 31, further comprising:
d) radiation crosslinking of the (preferably foamed) layer A and preferably also of the non-foamed top layer, with electron beams, with continuous passage of the entire layered material through a device for radiation before or after application of the varnish layer.

The support layer(s) or support film(s) must be able to withstand irradiation, since irradiation of the layered material takes place while including the support layer(s) or support film(s).

The foregoing embodiments and further embodiments, all of which may be combined with each other, are described in more detail below.

The layered material has one or more, preferably at least four or exactly four layers, preferably consisting of.

One of the layers is a layer A, which is preferably a foamed layer, said layer A having:
0-20 weight percent polyethylene as the first polymer,
30-80 weight percent of a second polymer selected from the group consisting of ethylene propylene diene monomer (EPDM), ethylene vinyl acetate copolymer (EVA), polyethylene octene (POE), ethylene butyl acrylate copolymer (EBA), and ethylene methacrylate copolymer (EMA);
10-40 weight percent filler, in particular calcium carbonate, such as chalk, wherein the organic component of the (foamed) layer A has a bio-based carbon (BBC) content of at least 50%, or at least 65%, as determined by ASTM D6866-16 Method B (AMS), and wherein

the layer material has a thickness of up to 4 cm.

The layer material is in particular a foamed film or consists of several films, one of which is a foamed film, in particular one or more foamed films on one or more support films or support layers. A support film or support layer can be, for example, a cotton layer. If required, the various layers or films can be bonded together.

The layered material has four or more layers with the following sequence:
textile support layer;
foamed layer A;
non-foamed top layer; and
varnish layer.

If necessary, further layers are present. These can then be applied on the outside, i.e. on the textile support layer or the varnish layer, and/or can be arranged between the textile support layer and the foamed layer A, and/or the foamed layer A and the non-foamed top layer, and/or non-foamed top layer and varnish layer.

The textile support layer consists of textiles that offer flexibility and tear resistance, for example polyester or polyester/cotton or cotton or linen fabric, preferably cotton. In particular, woven or non-woven (flow) fibers are used here.

Foamed layer A has an impact on the feel because it is soft and flexible.

The top layer is the layer that is visible to the outside. Therefore, the overlying varnish layer must be transparent. Therefore, it brings the color and is usually embossed with a pattern, preferably with a leather look.

The varnish layer imparts leather-like properties with regard to gliding, i.e. it does not exhibit rubber-like adhesive properties.

The polyethylene in (foamed) layer A may be selected from the group consisting of VLDPE, LDPE, HDPE, and LLDPE, preferably LLDPE. It is also possible to use combinations of polyethylene types.

In the context of the present invention, the term VLDPE (very low density polyethylene) preferably refers to a polyethylene with a density in the range of 0.880 g/cm³ to 0.915 g/cm³, determined according to ISO 1183.

In the context of the present invention, the term LDPE (low density polyethylene or polyethylene with low density because of branched polymer chains) preferably refers to a polyethylene with a density in the range of greater than 0.910 g/cm³ to 0.940 g/cm³, determined according to ISO 1183.

In the context of the present invention, the term HDPE (high density polyethylene) preferably refers to a polyethylene with a density of at least 0.940 g/cm³, for example up to 0.970 g/cm³ determined according to ISO 1183.

In the context of the present invention, the term LLDPE (linear low density polyethylene, or linear low density polyethylene whose polymer molecules have only short branches) preferably refers to a polyethylene with a density in the range of 0.915 g/cm³ to 0.925 g/cm³, determined according to ISO 1183.

The thickness of the layered material is up to 4 cm and depends on the type of application or the end product to be manufactured. The thickness can also be only up to 2 cm, for example 0.01 cm to 1.0 cm or 0.01 to 0.5 cm. The (preferably foamed) layer A can, for example, have a density between 0.3 and 1.2 g/cm³, for example 0.5 and 0.8 g/cm³.

The total amount of the first and the second polymer in the (foamed) layer A may be, for example, at least 50 weight percent, or 60 weight percent, for example 60-90 weight percent. The total amount depends on the amount of fillers used. The use of fillers makes a product cheaper, but an increasing amount of fillers has a negative effect on the material properties. Surprisingly, the material properties of the layered material according to the invention are very good, although an amount of filler of about 30% has been used (see examples).

The (preferably foamed) layer A may also contain further polymers, for example one or two further polymers. These further polymers may be present, for example, in an amount of 1-20 weight percent or 1-10 weight percent. Preferably, however, the (preferably foamed) layer A contains neither polyvinyl chloride nor polyurethane.

The (preferably foamed) layer A can be extruded using a blowing agent, e.g. azodicarboxamide or hollow microspheres, for example in an amount of 0.2-10, or 0.2-3%, by weight. Extrusion can be carried out at 120° C.-230° C., for example. The extrusion can be carried out with or without mixing elements. Similarly, it is possible to produce the layer in a calendering process, using heated rolls, for example at a temperature of 100 to 170° C., preferably 120 to 150° C., more preferably 130 to 140° C.

Preferably, the use of the blowing agent results in a foam structure with a pore diameter of less than 300 μm, preferably less than 200 μm, for example the pores have a diameter between 10 and 200 μm. The pore diameter can be determined using an electron microscope or light microscope. For example, the characteristic that the pores have a diameter between 10 and 200 μm is fulfilled if 20 pores in a radius around a selected pore all have the required diameter.

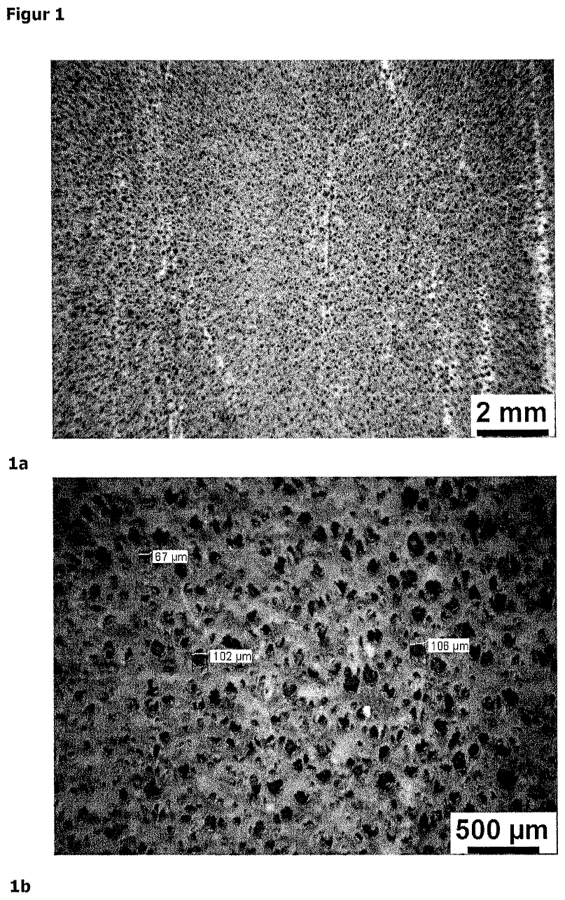

The microspheres/hollow microspheres are preferably not mixed during compounding (mixing of all raw materials), but are only used during extrusion or calendering. The extruded/calendered layer material is then full of microbubbles (for example, about 50 to about 150 um in diameter, see FIGS. 1-4). This makes the layered material even more flexible, and also more pleasant (soft touch). Similarly, gas-generating chemical blowing agents can be used. This is more cost-effective than microspheres/hollow microspheres.

The (preferably foamed) layer A can be crosslinked with electron beams to achieve desired material properties. Electron beam crosslinking can be carried out using equipment which accelerates electrons to approximately the speed of light by means of a high voltage of up to 10 million volts in a high vacuum. In addition to a high-voltage generator, the equipment for this purpose has an accelerator tube that directs the electrons via a deflector magnet onto the surface to be irradiated. Using electron accelerators, the layered material is crosslinked within a few seconds. Homogeneous irradiation and thus homogeneous crosslinking is ensured by specifically adapted handling systems. Here, the electron beam is deflected in X and Y directions to create a homogeneous radiation field through which the product (artificial leather) is continuously passed once or several times to effect crosslinking.

In radiation crosslinking, no peroxides or silanes are incorporated into the plastic compounds as in chemical crosslinking. Therefore, fewer or no secondary or cleavage products such as water, methane, alcohol, etc. are formed in the plastic. The crosslinking process chemically links the filament molecules (in the amorphous phase) to one another. This creates a three-dimensional network. The filament molecules can no longer move freely (regardless of temperature). Above the melting temperature, the material can no longer flow, but changes to a rubbery elastic state. The quantitative ratio between the first and second polymers, or any other polymers that may be present, can be determined using infrared spectroscopy.

The (preferably foamed) layer A, for example 0.1 cm thick, can be electron beam crosslinked with a voltage of 1.05 MeV, with an energy of at least 50 kGy, 100 kGy, 150 kGy, 200 kGy, or 250 kGy. The amount of energy of the radiation can be selected depending on the desired material property, with higher energy leading to higher crosslinking, resulting in lower flexibility but also lower hot set value. Layer A can have a Hot Set at 200° C. of less than 100%, preferably less than 50% or less than 30%, for example 10-30%, measured according to DIN EN 60811-507 (VDE 0473-811-507)—Thermal expansion test for crosslinked materials. For example, a value of “30/10” means: Hot Set 30% (+30% elongation at 200° C. after 15 minutes (under a load defined in the standard, usually 20 N/cm²)/Hot Set 10% (+10% elongation at 200° C. after 5 minutes after removal of the load (no more weight)).

During the process of crosslinking, the structure of at least layer A changes (and at sufficiently high voltage also inside, the voltage being chosen appropriately). Typically, an electron beam of 10 MeV at a material density of 1 g/cm³ is able to penetrate 40 mm deep. Preferably, a degree of crosslinking of at least 50%, preferably at least 60%, or at least 70%, further preferably at least 80%, for example 70-90%, is achieved. The degree of crosslinking can be determined by means of known extraction methods, in particular according to DIN EN ISO 10147:2013 or DIN ISO 6427.

The organic component of layer A has a bio-based carbon content of at least 50%, at least 60%, preferably at least 70%, determined according to ASTM D6866-16 Method B (AMS). The bio-based carbon content refers to all carbon-containing components of layer A, including organic fillers and additives. Preferably, the BBC of the organic components without fillers is also at least 50%, at least 60%, preferably at least 70%, determined according to ASTM D6866-16 Method B (AMS).

Layer A can have a σ₁₀ value of less than 10 MPa, preferably less than 7 MPa, for example 0.5-7 MPa, or 0.5-3 MPa, measured on a 1 mm plate, measured according to DIN EN 60811-501 (VDE 0473-811-501).

An expandable lightweight filler can be used as a blowing agent in the foamed layer A (or in another foamed layer of the layered material). For example, expanded hollow microspheres, preferably polymer-based hollow microspheres (for example EXPANCEL from the company AKZO NOBEL or ADVANCEL from the company SEKISUI) or mineral-based hollow microspheres (e.g. alumino-silicates), may be included.

Silicone additives can be used in particular to improve the material processability, in particular polydimethylsiloxanes can be used, for example the additive DC 50-320 from the company DOW CORNING, possibly also Tegomer V-Si 4042 or Tegopren 5885 from the company EVONIK. Other additives that can be used in the context of the present invention are, for example, antioxidants (e.g. Songnox 1010 from the company Songwong, or Ethanox 310 from the company Albemarle), UV absorbers (Tinuvin 111 and Chimassorb from the company BASF, Hostavin from the company Clariant), Hindered Amine Light Stabilizers (HALS, UV+antioxidant). Additives can be used, for example, in amounts of 0-10% by weight, preferably 0.5-3% by weight.

In particular, the layer material is in the form of a artificial leather. Here, the layer material can also be used in crosslinked or non-crosslinked form. To produce artificial leather, films can be produced which are applied to a support layer. The layer material is thus in the form of a film or tape. Films can, for example, be extruded with a wide slot die in a width of 2-3 m or calendered with a rolling mill.

For example, the second polymer in layer A may be ethylene propylene diene monomer (EPDM), or ethylene-vinyl acetate copolymer (EVA). For example, the polyethylene in layer A may be an LLDPE and the second polymer may be ethylene-vinyl acetate copolymer (EVA). Alternatively, the polyethylene in layer A may be an LLDPE and the second polymer may be ethylene propylene diene monomer (EPDM).

In one embodiment, the polyethylene is present in the (preferably foamed) layer A in an amount of 0-15, or 5-15, preferably 5-12 weight percent and the second polymer preferably ethylene propylene diene monomer (EPDM) and is present in an amount of 30-80, or 60-80 weight percent.

In one embodiment, the foamed layer A has, preferably consists of:
0-15 or 1-15 weight percent polyethylene,
50-80 weight percent ethylene propylene diene monomer (EPDM), as the second polymer,
10-40 weight percent filler(s), for example chalk,
1-3 weight percent expanded hollow microspheres,
0-3 weight percent silicone additive
0.5-3% by weight antioxidant and UV absorber.

In principle, the choice of fillers is not limited. In the case of carbon-based organic fillers, a high BBC value is required to get to the desired high BBC value for the entire Layer A. Possible fillers are, for example: Chalk, wood fibers, wood powder, dried apple powder, kaolin, talc, aluminum trihydroxide (ATH), and magnesium dihydroxide (MDH).

The fillers can also be used as blends.

With regard to the eco-balance of the layered material, a natural filler is preferred, for example calcium carbonate (such as chalk), wood fibers, wood powder, dried apple powder, kaolin, or talc, or mixtures thereof. In the case of plant-based fillers, the BBC of the entire layer may be high.

In one embodiment, the foamed layer A has, preferably consists of:
0-20 or 5-12 weight percent polyethylene,
35-65 weight percent ethylene propylene diene monomer (EPDM), as the second polymer,
20-35 weight percent filler(s), for example chalk,
1-3 weight percent expanded hollow microspheres or no solid expanding agents,
1-3 weight percent ethylene vinyl acetate copolymer (EVA),
1-2 weight percent silicone additive (silicone+EVA), and
0-0.5 weight percent of antioxidant.

The ethylene-vinyl acetate copolymer (EVA) can be used as a blend with a silicone polymer, e.g. Dow Corning MB 50-320 (EVA/silicone, 50/50). Increasing the proportion of fillers makes the product more cost-effective, but it leads to a reduction in flexibility.

In one embodiment of the layered material, the foamed layer A has the following components, preferably consists of:
0-20 weight percent polyethylene,
35-65 weight percent ethylene propylene diene monomer (EPDM), as the second polymer,
20-35 weight percent filler(s), preferably chalk or wood fibers,
1-3 weight percent expanded organic polymer hollow microspheres, or no solid expanding agent,
0-2 weight percent silicone additive, and
0-0.5% weight percent antioxidant.

In another embodiment of the layered material, the foamed layer A has the following components, preferably consists of:
1-10, preferably 6-9, weight percent polyethylene,
60-80 weight percent ethylene propylene diene monomer (EPDM), as the second polymer,
10-40 weight percent filler(s), preferably chalk or wood fibers,
1-3 weight percent expanded organic polymer hollow microspheres,
0-2 weight percent silicone additive, and
0-0.5 weight percent antioxidant.

In another embodiment of the layered material, the foamed layer A has the following components, preferably consists of:
1-10, preferably 6-9, percent by weight polyethylene,
60-80 weight percent ethylene propylene diene monomer (EPDM), as the second polymer,
10-40 weight percent filler(s), preferably chalk or wood fibers,
1-3 weight percent gas evolving chemical blowing agent,
0-2 weight percent silicone additive, and
0-0.5% weight percent antioxidant.

In addition, the (preferably foamed) layer A may contain pigments and/or dyes.

If the layered material has more than one layer, the layer A may be applied to a backing layer, for example a fabric layer. For example, the fabric layer may be made of cotton, flax fiber, and polyester, e.g., 50 weight percent cotton and 50 weight percent polyester. To achieve a high BBC value of the entire layered material, the support layer and each additional layer may also have a high BBC value. The layered material may then have an overall BBC of at least 50%, preferably at least 70% or even at least 80%, determined according to ASTM D6866-16 Method B (AMS).

Preferably, the layered material contains no plasticizers, or only bio-based plasticizers. The use of non-biobased plasticizers would lead to a lowering of the BBC value of layer A, which is not desirable.

In one embodiment, the layered material is vegan or does not contain animal-derived starting materials.

The invention further relates to a method for producing the layered material according to any of the preceding embodiments, comprising:
a) providing the composition for the (preferably foamed) layer A according to any of the embodiments described herein, for example embodiments 1-30,
b) extruding or calendering the composition of step (a) into a layered material.

Further, the method may comprise the following step:
c) radiation crosslinking of the (preferably foamed) layer A with electron beams, thereby preferably also crosslinking the top layer, with continuous passage of the layer A or the entire layered material through a device for irradiation.

In a further step, the extruded/calendered (preferably foamed) layer A can be applied to a support layer. Depending on whether the support layer(s) or support film(s) resist irradiation, the irradiation can take place before or after the application of the (preferably foamed) layer A to the support layer(s) or support film(s).

Extrusion is preferably carried out using mixing. This results in a more homogeneous distribution of the dyes and microbubbles.

Thus, the invention thus also relates to a layered material produced using the process according to the invention. The invention also relates to a layered material having four or more layers as described above, wherein the following composition for layer A is extruded/calendered:
0-20, preferably 5-15, 1-10, weight percent polyethylene as the first polymer,
30-80 weight percent of a second polymer selected from the group consisting of ethylene propylene diene monomer (EPDM), ethylene vinyl acetate copolymer (EVA), polyethylene octene (POE), ethylene butyl acrylate copolymer (EBA), and ethylene methacrylate copolymer, preferably EPDM;
10-40 weight percent filler, in particular calcium carbonate, such as chalk, wherein the organic component of the foamed layer has a bin-based carbon (BBC) content of at least 50% as determined by ASTM D6866-16 Method B (AMS), and wherein the layered material has a thickness of up to 4 cm. This embodiment may be combined with any of the embodiments described herein, particularly embodiments 2-30.

In one embodiment of the invention, which can be combined with all embodiments described herein, in particular embodiments 2-30, the invention relates to a layered material having at least one (preferably foamed) layer A, comprising:
0-20, preferably 1-10, weight percent polyethylene as the first polymer,
50-90, preferably 60-80, weight percent of a second polymer selected from the group consisting of ethylene propylene diene monomer (EPDM), ethylene vinyl acetate copolymer (EVA), polyethylene octene (POE), ethylene butyl acrylate copolymer (EBA), and ethylene methacrylate copolymer (EMA);
10-40 weight percent filler, in particular calcium carbonate, such as chalk, wherein the organic component of the (foamed) layer has a bio-based carbon (BBC) content of at least 50% as determined by ASTM D6866-16 Method B (AMS); and

wherein the layered material has a thickness of up to 4 cm.

### Definitions

The term “weight percent” refers to the total weight of the composition.

The term “polymer” as used herein refers to molecules having a high number of repeating units (monomers) bonded together, with organic monomers being preferred. One type of polymer (e.g., the “first polymer”) is distinguished from another type of polymer (e.g., the “second polymer”) by the nature of the monomers. The term “copolymer” as used herein refers to a polymer having more than one type of monomers.

The term “biobased” is used here to refer only to carbon-containing organic materials, with the “BBC” or “bio-based content” indicating how much biobased carbon is present relative to the total carbon. For a petroleum-derived material, the BBC is equal to 0%. For a polymer made only from renewable resources, the BBC is equal to 100%.

Bio-based carbon has a high content of ¹⁴C isotope. Since the ¹⁴C isotope is formed only by irradiation in the atmosphere and decays slowly, petroleum-derived material that has not been exposed to radiation in the atmosphere for a long time does not have ¹⁴C isotopes. On the other hand, a plant that has metabolized CO₂ from the atmosphere in recent years (1-1000 years, or 1-500, or 1-100 years) has a high content of ¹⁴C isotopes.

The BBC value or bio-based fraction can be determined using the standard “ASTM D6866-16 Method B (AMS)” (reference is, in particular, oxalic acid II), in particular using AMS (accelerator mass spectroscopy). Here, the total content of organic carbon in the material to be considered, e.g. the layered material according to the invention or the (foamed) layer A thereof, or a component of the layered material, is taken as a basis and the proportion of ¹⁴C isotope is determined. For this purpose, the organic carbon is oxidatively converted (e.g. by combustion or reaction with reduced copper oxide (metal wire/powder), e.g. at 900° (but below the temperature leading to lime burning or oxidation of other inorganic fillers present) into CO₂. Inorganic materials such as calcium carbonate then remain inert and are not co-determined. The generated CO₂ is then treated in a series of dry ice/methanol water traps (˜−78° C.) and, depending on the nature of the sample, further purified in a series of nitrogen/pentane traps (˜−129° C.) if required. Elemental carbon (graphite) for AMS measurement is then effected using, for example, the Bosch reaction (Manning MP, Reid RC., “C-H-O systems in the presence of an iron catalyst” Industrial & Engineering Chemistry Process Design and Development 1977, 16:358-61). See also Vogel et al, “Performance of catalytically condensed carbon for use in accelerator mass spectrometry” Nuclear Instruments and Methods in Physics Research 1984 B 5(2):289-93. The calibration of the measurement is based on the oxalic add II standard.

According to US2013022771, a BBC of 1% corresponds to a ¹⁴C/¹²C isotope ratio of 1.2×10⁻¹⁴.

The term “natural” in the context of a component of the coating material according to the invention means that the component in its form used occurs naturally and has not been produced synthetically. For example, fillers such as wood powder and chalk, and certain mineral fillers (e.g. carbonates, hydroxides, sulfates, oxides, or silicates) are “natural”, whereas organic polymers, chemically modified (silane-modified) materials, or certain mineral fillers (e.g. precipitated carbonates, pyrogenic silica, or precipitated hydroxides) are to be classified as “synthetic” or “non-natural”.

Within the scope of the present invention, therefore, materials with a bio-based carbon content of at least 50%, at least 70%, preferably at least 80%, determined according to ASTM D6866, are generally preferred.

For example, the company Braskem (Brazil) or the company FKuR (Germany) offers a bio-based polyethylene (LLDPE) with a BBC greater than 87%. Biobased EPDM with a BBC of 70% is available, for example, from the company ARLANXEO (Netherlands).

The present disclosure will be further explained with reference to figures:

FIG. 1a/b shows the layered material VKL068 with 1% Expancel 950MB80, extruded at 200° C. (without mixing elements) at different magnifications. Before the picture was taken, the test sample (or tape) was split. The purpose of splitting the sample is to be able to observe the core of the material and in particular the way in which the dye is dispersed, as well as the distribution and size of the microbubbles after the microspheres have expanded during extrusion. Here, “ . . . extruded . . . without mixing elements . . . ” means that the screw in the extruder is constructed with conveying only. In principle, for a screw of an extruder there are the conveying elements (these serve in particular to convey the mass), and the mixing (these serve in particular to improve mixing/integration of the various components). Therefore, it can be observed that the distribution of the components is better/more homogeneous with the mixing elements.
Image acquisition method: The specimen to be photographed as a thin film is placed on the specimen holder of a LEICA MS5 microscope. The desired magnification is selected and a photo is taken using a JENOPTIK Model ProgRes Speed XT Core 5 camera.

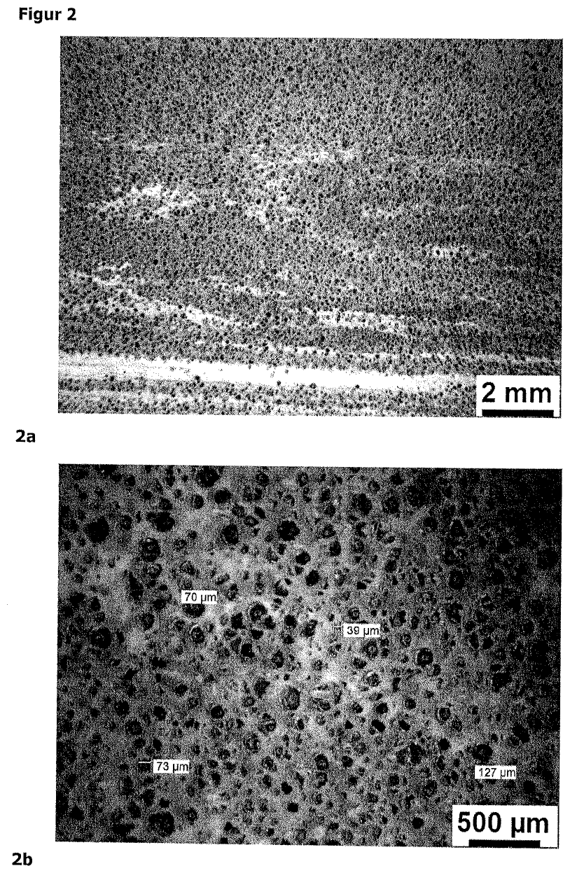

FIG. 2a/b shows the layered material VKL070 with 1% Expancel 950MB80 extruded at 180° C. (without mixing elements) at different magnifications. Before the picture was taken, the test sample was split.

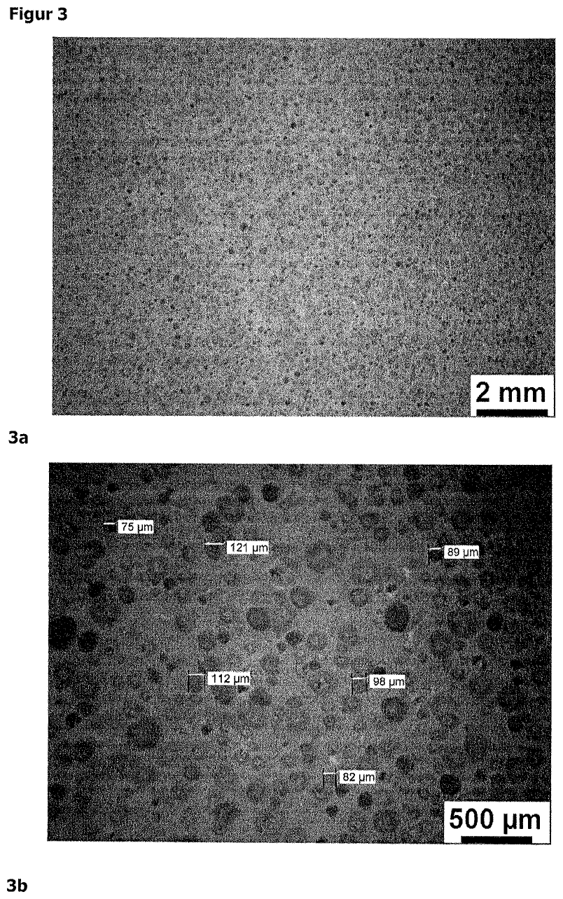

FIG. 3a/b shows the layered material VKL070 with 1.5% Expancel 950MB120 extruded at 200° C. (with mixing elements) at different magnifications. Before the image was taken, the test sample was split. It was observed that the dispersion of the color masterbatch and the distribution of microbubbles become more homogeneous when mixing elements are used during extrusion. Here, “ . . . extruded . . . with mixing elements . . . ” means that the screw in the extruder is constructed with conveying and mixing elements.

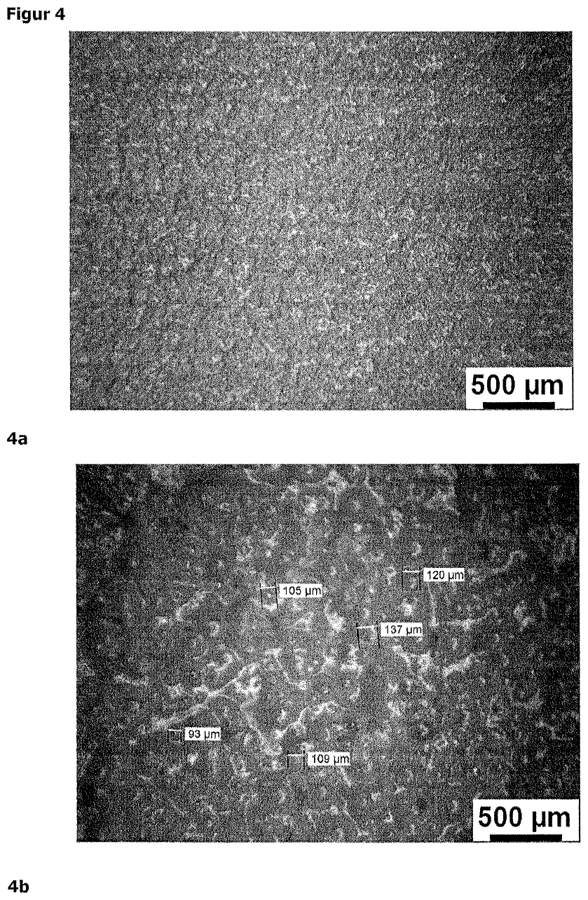

FIG. 4a/b shows the layer material VKL070 with 1.5% Expancel 950MB120 extruded at 200° C. (with mixing elements) at different magnifications. The images were taken from the tape surface.

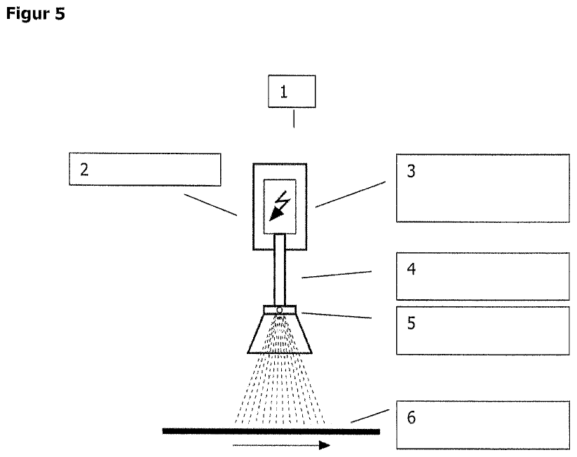

FIG. 5 shows the structure of a device for radiation crosslinking, where the reference signs are as follows: 1: Radiation crosslinking apparatus; 2: Accelerator; 3: High voltage generator pressure tank with SF₆ gas; 4: Accelerator tubes; 5: Deflection magnet; 6: Layered material.

### EXAMPLES

The production of layered materials according to the invention can be carried out as described below.

The first step is about homogeneously mixing the various components of the compound, which is then used for extrusion or calendering of the layered material. A bus kneader can be used advantageously for this purpose. First, the entire compounding system must be cleaned and assembled. The various raw materials, except the blowing agent, for example Expancel microspheres, and the color masterbatch, are metered/incorporated into the bus kneader according to the desired composition for the compound.

The temperature profile is selected according to the raw materials so that sufficient shear allows good distribution of the various components. The compound mass is granulated and the corresponding granules are then cooled down to room temperature.

A second step is about extruding or calendering a film with the granules as produced above. For example, an extruder with a wide slot die, the width of which is selected depending on the width of the artificial leather coil or layered material to be produced, can be used advantageously for this purpose. First, the entire extrusion system must be cleaned and assembled. The granules, this time with the blowing agent for the foamed layer, for example the Expancel microspheres, and the color masterbatch, are metered and/or incorporated in the extruder according to the desired composition for the compound. Preferably, a screw with conveying and mixing is used so that the microspheres and the color masterbatch can be distributed well and homogeneously.

The temperature profile is chosen depending on the starting materials (compound in granular form) and in particular according to the types of microspheres to allow optimal expansion of the microspheres.

No blowing agent is used for the top layer, which is coextruded with the foamed layer. The compound for the top layer can be the same compound as for the foamed layer. However, the compound may be slightly different, but in any case it is also bio-based. However, it does not contain a blowing agent. Both compounds are then coextruded on a textile carrier material (cotton, cotton/polyester . . . ).

In a third step, the varnish is then applied to the top layer surface and dried. Before applying the varnish layer, it may be necessary to use a pretreatment, such as surface activation by a cold plasma corona treatment, to activate the surface of the top layer and enable good adhesion of the varnish.

In a fourth step, it is then possible, if desired, to perform radiation crosslinking of the previously obtained vegan bio-based artificial leather film or layered material. The radiation dose and thus the corresponding crosslinking density are selected according to the intended application. For a film thickness of about 1 mm, and with a 1.05 MeV voltage, a radiation dose of 25 to 300 KGy, preferably 50 to 100 KGy, can advantageously be selected.

Using the method described above and the starting materials described below, the layered material samples VKLO68, VKL070, VKL074, VKL075 (see Table 1), and VKL062, VKL063, VKL064, VKL065, VKL066, VKL067, and VKL069 (see Table 2) were prepared.

SLL318 is a bio-based LLDPE (Linear Low Density Polyethylene) from the company BRASKEM/Brazil (represented in Europe by the company FKuR (Germany)). The Bio-based content is at least 87%.

Hydrocarb 95T-OG is natural chalk from the company OMYA.

DC 50-320 is a silicone additive (50% silicone on EVA polymer as carrier) from Dow Corning.

Keltan ECO 5470 is a bio-based EPDM from ARLANXEO/Netherlands.

Kelton 5508 ECO is a bio-based EPDM from ARLANXEO/Netherlands.

Expancel 950MB80 are microspheres from the company AKZO NOBEL (Sweden), which can expand very much with heat (from a given temperature, from about 120 to about 200° C. depending on the type).

Songnox 1010 is a phenolic antioxidant.

TABLE 1

| | VKL068 | VKL074 | VKL070 | VKL075 |
|---|---|---|---|---|
| SLL318 (LLDPE) | 33.50 | 33.50 | 25.00 | 25.00 |
| Hydrocarb 95T-OG (chalk) | 29.50 | 28.00 | 29.50 | 27.50 |
| DC 50-320 (EVA base, silicone | 2.00 | 2.00 | 2.00 | 2.00 |
| additive) | | | | |
| Keltan ECO 5470 (EPDM) | 33.70 | | 42.20 | |
| Keltan 5508 ECO = Keltan ECO | | 35.20 | | 44.20 |
| 5470 powdered with chalk | | | | |
| (EPDM) | | | | |
| Expancel | 1.00 | 1.00 | 1.00 | 1.00 |
| 950 MB 80 (microspheres) | | | | |
| Songnox 1010 (antioxidant) | 0.30 | 0.30 | 0.30 | 0.30 |
| Total | 100.00 | 100.00 | 100.00 | 100.00 |
| Colors Masterbatch (optional) | 2% Black MB | 2% Black MB | 2% Black MB | 2% Black MB |
| Mechanics 1 mm plate | 21.4¹⁾ | 20.3¹⁾ | 16.2¹⁾ | 20.5¹⁾ |
| σ (strength) in MPa | 18.3²⁾ | | 18.0²⁾ | |
| | 17.7³⁾ | | 16.1³⁾ | |
| Mechanics 1 mm plate | >800¹⁾ | 942¹⁾ | >700¹⁾ | 917¹⁾ |
| ε (Elongation at break) in % | >600²⁾ | | >600²⁾ | |
| | 522³⁾ | | 515³⁾ | |
| Mechanics 1 mm plate | 4.5¹⁾ | 4.0¹⁾ | 3.3¹⁾ | 2.8¹⁾ |
| σ₁₀ (strength at 10% | 4.4²⁾ | | 3.5²⁾ | |
| elongation) in MPa | 4.8³⁾ | | 3.2³⁾ | |
| Hot set (200° C.) | 50/10²⁾ | — | 35/10²⁾ | — |
| | 25/5³⁾ | | 15/5³⁾ | |
| BBC (Bio-based Content), | 74.80% | 74.80% | 72.75% | 72.75% |
| calculated | | | | |
| BBC (Bio-based Content) | 74.80% | 75.01% | 72.75% | 72.78% |
| measured by BetaAnalytic | | | | |
| according to ASTM D6866-16 | | | | |
| Method B (AMS) | | | | |

¹⁾not crosslinked
²⁾cross-linked with 50 kGy
³⁾cross-linked with 100 kGy

TABLE 2

| | VKL062 | VKL063 | VKL064 | VKL065 | VKL066 | VKL067 | VKL069 |
|---|---|---|---|---|---|---|---|
| SLL318 | 38.00 | 37.00 | 37.00 | 37.00 | 36.70 | 36.70 | 30.00 |
| (LLDPE) | | | | | | | |
| Hydrocarb | 29.70 | 29.70 | 29.70 | 29.70 | 29.50 | 29.50 | 29.50 |
| 95T-OG | | | | | | | |
| DC 50- | 2.00 | 3.00 | 2.00 | 2.00 | 2.00 | 2.00 | 2.00 |
| 320 (EVA | | | | | | | |
| base) | | | | | | | |
| Keltan | 30.00 | 30.00 | 30.00 | 30.00 | 29.50 | 29.50 | 37.20 |
| ECO 5470 | | | | | | | |
| Expancel | | | 1.00 | | 2.00 | | 1.00 |
| 950 MB 80 | | | | | | | |
| Expancel | | | | 1.00 | | 2.00 | |
| 980 MB 120 | | | | | | | |
| Songnox | 0.30 | 0.30 | 0.30 | 0.30 | 0.30 | 0.30 | 0.30 |
| 1010 | | | | | | | |
| Total | 100.00 | 100.00 | 100.00 | 100.00 | 100.00 | 100.00 | 100.00 |
| Colors | 2% Black | 2% Black | 2% Black | 2% Black | 2% Black | 2% Black | 2% Black |
| Masterbatch | MB | MB | MB | MB | MB | MB | MB |
| Mechanics 1 mm | 20.7¹⁾ | 21.4¹⁾ | 18.9¹⁾ | 19.2¹⁾ | 19.0¹⁾ | 18.2¹⁾ | 19.0¹⁾ |
| plate σ | 16.8⁴⁾ | 17.0⁴⁾ | | | 16.9³⁾ | 16.8³⁾ | 18.2²⁾ |
| (strength) | 14.7⁵⁾ | 16.5⁵⁾ | | | 16.7⁴⁾ | 16.1⁴⁾ | 16.5³⁾ |
| in MPa | | | | | | | |
| Mechanics 1 mm | 796¹⁾ | 832¹⁾ | 808¹⁾ | 793¹⁾ | 838¹⁾ | 796¹⁾ | 1101¹⁾ |
| plate ε | 553⁴⁾ | 441⁴⁾ | | | 527³⁾ | 525³⁾ | >600²⁾ |
| (Elongation | 392⁵⁾ | 410⁵⁾ | | | 471⁴⁾ | 453⁴⁾ | 527³⁾ |
| at break) | | | | | | | |
| in % | | | | | | | |
| Mechanics 1 mm | | | 4.7¹⁾ | 4.7¹⁾ | 5.3¹⁾ | 5.1¹⁾ | 4.0¹⁾ |
| plate σ₁₀ | | | | | 5.2³⁾ | 5.1³⁾ | 4.0²⁾ |
| (strength | | | | | 5.1⁴⁾ | 5.4⁴⁾ | 4.0³⁾ |
| at 10% | | | | | | | |
| elongation) | | | | | | | |
| in MPa | | | | | | | |
| Hot set | 30/5²⁾ | 30/10²⁾ | | | 30/10²⁾ | 30/10²⁾ | 40/10²⁾ |
| (200° C.) | 15/5³⁾ | 15/5³⁾ | | | 30/5³⁾ | 25/5³⁾ | 20/5³⁾ |
| BBC (Bio- | 76.90% | 75.66% | 75.66% | 75.66% | 74.58% | 74.58% | 73.96% |
| based | | | | | | | |
| Content) | | | | | | | |

¹⁾not crosslinked
²⁾cross-linked with 50 kGy
³⁾cross-linked with 100 kGy
⁴⁾cross-linked with 150 kGy
⁵⁾cross-linked with 200 kGy

The mechanical properties of VKL070 seem to be particularly good compared to PVC or PUR artificial leathers. Elongation at break >500% and strength >16 MPa when crosslinked at 50 or 100 KGy. The hot set values are desirably low. This means that the material is very well crosslinked after radiation crosslinking, with the Bio-based Content (BBC) of organic component being above 72%. For a standard artificial leather made of PVC or PUR, the BBC is only 0%.

TABLE 3

| | LKL086 |
|---|---|
| SLL318 (LLDPE) | 7.50 |
| Hydrocarb 95T-OG (chalk) | 27.70 |
| DC 50-320 (EVA base, silicone | 2.00 |
| additive) | |
| Keltan ECO 5470 (EPDM) | |
| Keltan 5508 ECO = Keltan ECO | 62.50 |
| 5470 powdered with chalk | |
| (EPDM) | |
| Expancel | |
| 950 MB 80 (microspheres) | |
| Songnox 1010 (antioxidant) | 0.30 |
| Total | 100.00 |
| Colors Masterbatch (optional) | 2% Black MB |
| Mechanics 1 mm plate | 16.1¹⁾ |
| σ (strength) in MPa | |
| Mechanics 1 mm plate | 918¹⁾ |
| ε (Elongation at break) in % | |
| Mechanics 1 mm plate | 1.2¹⁾ |
| σ₁₀ (strength at 10% | |
| elongation) in MPa | |
| Hot set (200° C.) | |
| BBC (Bio-based Content) | 67% |

¹⁾not crosslinked

The use of higher amounts of EPDM and lower amounts of LLDPE results in significantly reduced σ10 values. This is particularly advantageous for the use of artificial leather, so that the properties do not become too stiff or paper-like, but instead acquire a leather-like flexibility.

The invention also relates to the following embodiments, wherein the term “claim” means “embodiment”.

1. Layered material having one or more layers, including at least one layer A, said layer A comprising:
10-50 weight percent polyethylene as the first polymer,
10-50 weight percent of a second polymer selected from the group consisting of ethylene propylene diene monomer (EPDM), ethylene vinyl acetate copolymer (EVA), polyethylene octene (POE), ethylene butyl acrylate copolymer (EBA), and ethylene methacrylate copolymer (EMA);
10-40 weight percent filler,
wherein the organic component of layer A has a bio-based carbon content (BBC) of at least 50% as determined by ASTM D6866-16 Method B (AMS);
and wheren
the layered material has a thickness of up to 4 cm.

2. The layered material according to claim 1, wherein layer A is a foamed layer.

3. The layered material according to claim 2, wherein the foamed layer A has been extruded using a blowing agent.

4. The layered material according to any one of claims 1 to 3, wherein the layer A is radiation crosslinked with electron beams.

5. The layered material according to any one of claims 1 to 4, wherein layer A has a hot set at 200° C. of less than 100%, preferably less than 50%, measured according to DIN EN 60811-507.

6. The layered material according to any one of claims 2 to 5, wherein an expandable lightweight filler is used as blowing agent in the foamed layer A.

7 The layered material according to any one of claims 1 to 6, in the form of a artificial leather.

8. The layered material of any one of claims 1 to 7, wherein the second polymer in layer A is ethylene-propylene-diene monomer (EPDM), or ethylene-vinyl acetate copolymer (EVA).

9. The layered material according to any one of claims 2 to 8, wherein the foamed layer comprises:
20-35 weight percent polyethylene,
30-50 weight percent ethylene propylene diene monomer (EPDM), as the second polymer,
20-35 weight percent filler(s),
1-3 weight percent expanded hollow microspheres,
0-3 weight percent silicone additive, and
IIch—0.5-3% weight percent antioxidant and, or UV absorber.

10. The layered material according to any one of claims 1 to 9, wherein layer A is applied to a support layer.

11. A method of producing the layered material according to any one of claims 1 to 10, comprising:
a) providing the composition for layer A,
b) extruding the composition from step (a) into a layered material.

12. The method of claim 11, further comprising:
c) radiation crosslinking of layer A with electron beams, with continuous passage of layer A or the entire layered material through a device for irradiation.

13. Layered material having one or more layers, at least one of which is foamed layer A, which has been prepared using an extrusion process, wherein the following composition is extruded:
10-50, weight percent polyethylene as the first polymer,
10-50 weight percent of a second polymer selected from the group consisting of ethylene propylene diene monomer (EPDM), ethylene vinyl acetate copolymer (EVA), polyethylene octene (POE), ethylene butyl acrylate copolymer (EBA), and ethylene methacrylate copolymer;
10-40 weight percent filler,

wherein the organic component of the foamed layer has a bio-based carbon (BBC) content of at least 50%, as determined by ASTM D6866-16 Method B (AMS), and wherein the layered material has a thickness of up to 4 cm.

### Cited Publications

US 2013/0022771 A1
US 2011/0183099 A1
EP2342262 (B1)

1. Layered material with four or more layers with the following order:
textile support layer;
foamed layer A;
non-foamed top layer; and
varnish layer; wherein
layer A comprises:
0-20 weight percent polyethylene as the first polymer,
30-80 weight percent ethylene propylene diene monomer (EPDM) as the second polymer;
10-40 weight percent filler,
wherein the organic component of layer A has a bio-based carbon content (BBC) of at least 50% as determined by ASTM D6866-16 Method B (AMS);
and wherein
the layered material has a thickness of up to 4 cm.

2. The layered material according to claim 1, wherein the foamed layer A has been extruded or calendered using a blowing agent.

3. The layered material according to claim 1, wherein the non-foamed top layer has a thickness less than layer A.

4. The layered material according to claim 1, wherein the layer A is radiation crosslinked with electron beams.

5. The layered material according to claim 1, wherein layer A has a hot set at 200° C. of less than 100%, preferably less than 50%, measured according to DIN EN 60811-507.

6. The layered material according to claim 2, wherein an expandable lightweight filler is used as blowing agent in the foamed layer A.

7. The layered material according to claim 1, in the form of an artificial leather.

8. The layered material according to claim 1, wherein the non-foamed top layer comprises:
1-20 weight percent polyethylene as the first polymer,
30-80 weight percent ethylene propylene diene monomer (EPDM) as the second polymer;
10-40 weight percent filler,
0-3 weight percent silicone additive, and
0.5-3 weight percent antioxidant and/or UV absorber
wherein the organic component of the top layer has a bio-based carbon (BBC) content of at least 50%, as determined by ASTM D6866-16 Method B (AMS);
and wherein
the layered material has a thickness of up to 4 cm; preferably, the material of layer A and the top layer is identical, with the difference that the top layer is not foamed and, in particular, has no blowing agents.

9. The layered material according to claim 2, wherein the foamed layer comprises:
1-15 weight percent of polyethylene,
50-80 weight percent ethylene propylene diene monomer (EPDM), as the second polymer,
10-40 weight percent filler(s),
1-3 weight percent expanded hollow microspheres,
0-3 weight percent silicone additive, and
0.5-3 weight percent antioxidant and/or UV absorber.

10. The layered material according to claim 1, wherein the varnish layer comprises or consists of acrylic resin, polyurethane and/or polytetrafluoroethylene (Teflon).

11. Method for producing the layered material according to claim 1, comprising:
a) providing the textile support layer, the composition for layer A, and the composition for the non-foamed top layer,
b) extruding or calendering the components of step (a) into a layered material, and
c) applying the varnish layer to the layered material from step b).

12. The method of claim 11, further comprising:
d) radiation crosslinking of the layered material with electron beams, with continuous passage of the layered material through a device for irradiation.

13. Layered material having four or more layers, at least one of which is a foamed layer A, which has been prepared using an extrusion process or a calendering process, wherein the following composition is extruded or calendered:
1-15 weight percent of polyethylene as the first polymer,
50-80 weight percent of a second polymer selected from the group consisting of ethylene propylene diene monomer (EPDM), ethylene vinyl acetate copolymer (EVA), polyethylene octene (POE), ethylene butyl acrylate copolymer (EBA), and ethylene methacrylate copolymer;
10-40 weight percent filler,
wherein the organic component of the foamed layer has a bio-based carbon (BBC) content of at least 50%, as determined by ASTM D6866-16 Method B (AMS), and wherein the layered material has a thickness of up to 4 cm.
